(19) United States
(12) Patent Application Publication
(10) Pub. No.: US 2022/0070369 A1
(43) Pub. Date: Mar. 3, 2022

(54) Camera Image Or Video Processing Pipelines With Neural Embedding

(71) Applicant: Spectrum Optix Inc., Vancouver (CA)

(72) Inventors: Kevin Gordon, Edmonton (CA); Martin Humphreys, Edmonton (CA); Colin D'Amore, Edmonton (CA)

(21) Appl. No.: 17/458,985

(22) Filed: Aug. 27, 2021

Related U.S. Application Data
(60) Provisional application No. 63/071,966, filed on Aug. 28, 2020.

(51) Int. Cl. H04N 5/232; G06N 3/04; G06N 3/08; G06T 3/40

(52) U.S. Cl. CPC H04N 5/23229; G06N 3/0454; H04N 5/23222; G06T 3/4046; G06N 3/08

(57) ABSTRACT

An image processing pipeline including a still or video camera includes a first portion of an image processing system arranged to use information derived at least in part from a neural embedding. A second portion of the image processing system can be used to modify at least one of an image capture setting, sensor processing, global post processing, local post processing, and portfolio post processing, based at least in part on neural embedding information.

### RELATED APPLICATION

This application claims the benefit of U.S. Provisional Application Ser. No. 63/071,966, filed Aug. 28, 2020, and entitled CAMERA IMAGE OR VIDEO PROCESSING PIPELINES WITH NEURAL EMBEDDING, which is hereby incorporated by reference in its entirety.

### TECHNICAL FIELD

The present disclosure relates to systems for improving images using neural embedding techniques to reduce processing complexity and improve images or video. In particular, described is a method and system using neural embedding to provide classifiers that can be used to configure image processing parameters or camera settings.

### BACKGROUND

Digital cameras typically require a digital image processing pipeline that converts signals received by an image sensor into a usable image. Processing can include signal amplification, corrections for Bayer masks or other filters, demosaicing, colorspace conversion, and black and white level adjustment. More advanced processing steps can include HDR in-filling, super resolution, saturation, vibrancy, or other color adjustments, tint or IR removal, and object or scene classification. Using various specialized algorithms, corrections can be made either on-board a camera, or later in post-processing of RAW images. However, many of these algorithms are proprietary, difficult to modify, or require substantial amounts of skilled user work for best results. In many cases, using traditional neural network methods is impractical due limited available processing power and high dimensionality of a problem. An imaging system may additionally make use of multiple image sensors to achieve its intended use-case. Such systems may process each sensor completely independently, jointly, or in some combination thereof. In many cases, processing each sensor independently is impractical due to the cost of specialized hardware for each sensor, whereas processing all sensors jointly is impractical due to limited system communication-bus bandwidth and high neural network input complexity. Methods and systems that can improve image processing, reduce user work, and allow updating and improvement are needed.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1A illustrates a neural network supported image or video processing pipeline;

FIG. 1B illustrates a neural network supported image or video processing system;

FIG. 1C is another embodiment illustrating a neural network supported software system;

FIGS. 1D-1G illustrate examples of a neural network supported image processing;

FIG. 2 illustrates a system with control, imaging, and display sub-systems;

FIG. 3 illustrates one example of neural network processing of an RGB image;

FIG. 4 illustrates an embodiment of a fully convolutional neural network;

FIG. 5 illustrates one embodiment of a neural network training procedure;

FIG. 6 illustrates a process for reducing dimensionality and processing using neural embedding;

FIG. 7 illustrates a process for categorization, comparing, or matching using neural embedding;

FIG. 8 illustrates a process for preserving neural embedding information in metadata;

FIG. 9 illustrates general procedures for defining and utilizing a latent vector in a neural network system;

FIG. 10 illustrates general procedures for using latent vectors to pass information between modules of various vendors in a neural network system;

FIG. 11 illustrates bus mediated communication of neural network derived information, including a latent vector;

FIG. 12 illustrates image database searching using latent vector information; and

FIG. 13 illustrates user manipulation of latent vector parameters.

### DETAILED DESCRIPTION

In some of the following described embodiments, systems for improving images using neural embedding information or techniques to reduce processing complexity and improve images or video are described. In particular, a method and system using neural embedding to provide classifiers that can be used to configure image processing parameters or camera settings. In some embodiments, methods and systems for generating neural embeddings and using these neural embeddings for a variety of applications including: classification and other machine learning tasks, reducing bandwidth in imaging systems, reducing compute requirements in neural inference systems (and as a result power), identification and association systems such as database queries and object tracking, combining information from multiple sensors and sensor types, generating novel data for training or creative purposes, and reconstructing system inputs.

In some embodiments, an image processing pipeline including a still or video camera further includes a first portion of an image processing system arranged to use information derived at least in part from a neural embedding. A second portion of the image processing system can be used to modify at least one of an image capture setting, sensor processing, global post processing, local post processing, and portfolio post processing, based at least in part on neural embedding information.

In some embodiments, an image processing pipeline can include a still or video camera that includes a first portion of an image processing system arranged to reduce data dimensionality and effectively downsample an image, images, or other data using a neural processing system to provide neural embedding information. A second portion of the image processing system can be arranged to modify at least one of an image capture setting, sensor processing, global post processing, local post processing, and portfolio post processing, based at least in part on the neural embedding information.

In some embodiments, an image processing pipeline can include a first portion of an image processing system arranged for at least one of categorization, tracking, and matching using neural embedding information derived from a neural processing system. A second portion of the image processing system can be arranged to modify at least one of an image capture setting, sensor processing, global post processing, local post processing, and portfolio post processing, based at least in part on the neural embedding information.

In some embodiments, an image processing pipeline can include a first portion of an image processing system arranged to reduce data dimensionality and effectively downsample an image, images, or other data using a neural processing system to provide neural embedding information. A second portion of the image processing system can be arranged to preserve the neural embedding information within image or video metadata.

In some embodiments, an image capture device includes a processor to control image capture device operation. A neural processor is supported by the image capture device and can be connected to the processor to receive neural network data, with the neural processor using neural network data to provide at least two processing procedures selected from a group including sensor processing, global post processing, and local post processing.

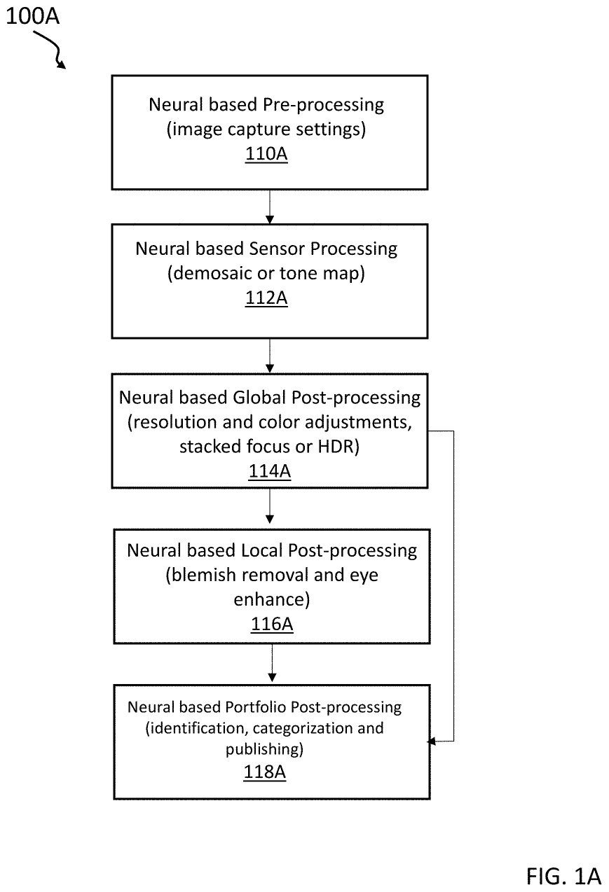

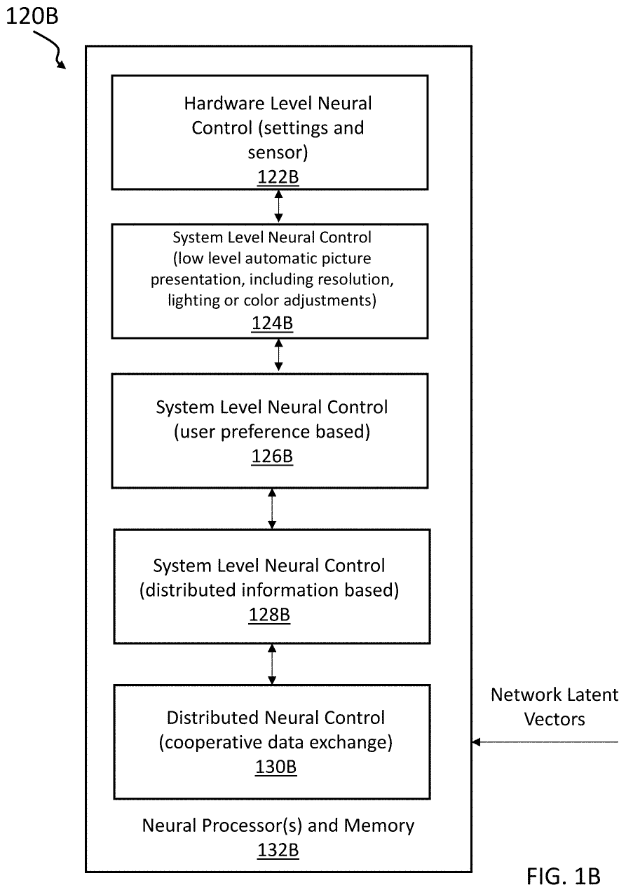

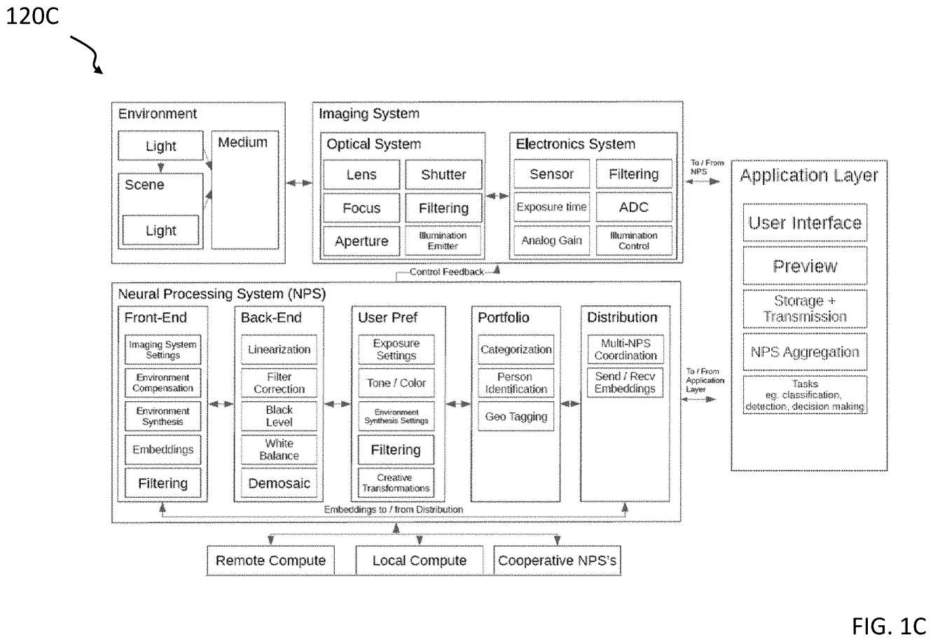

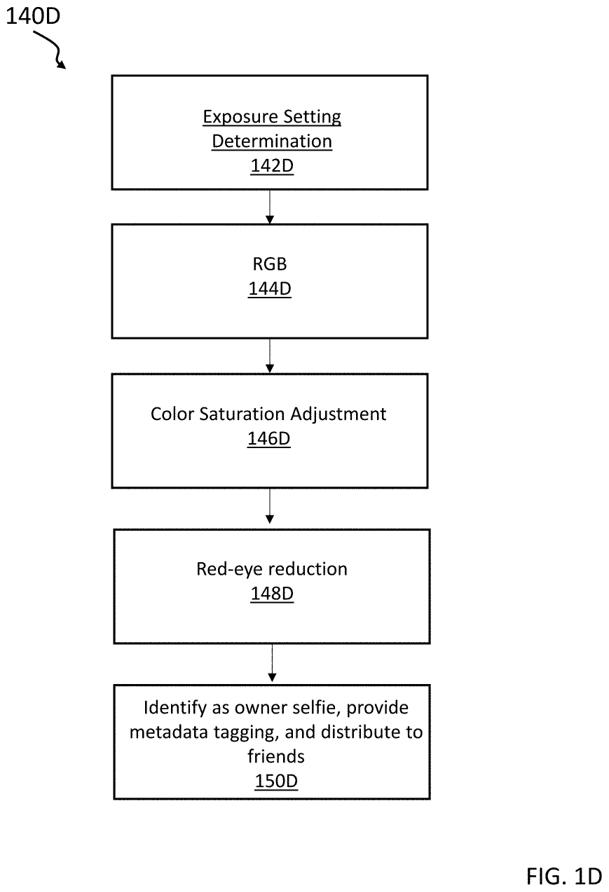

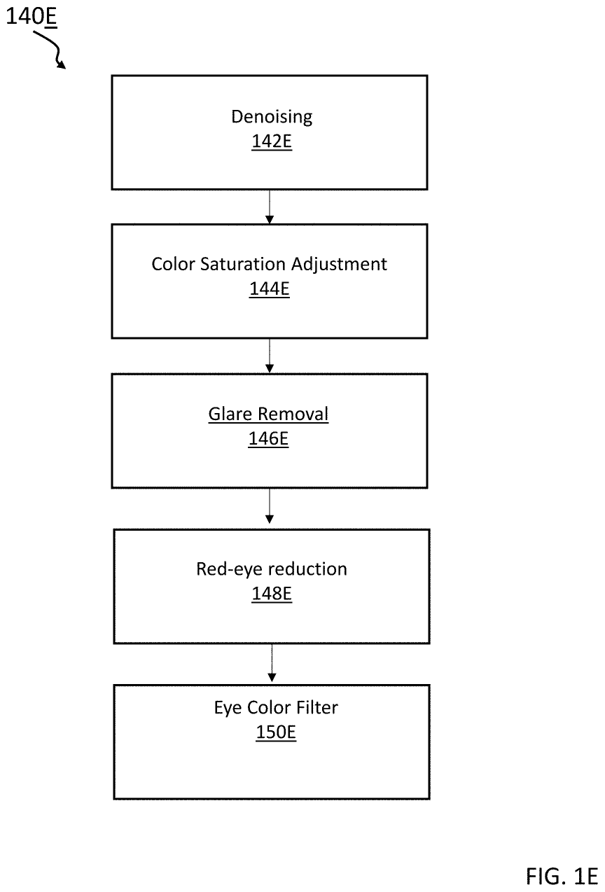

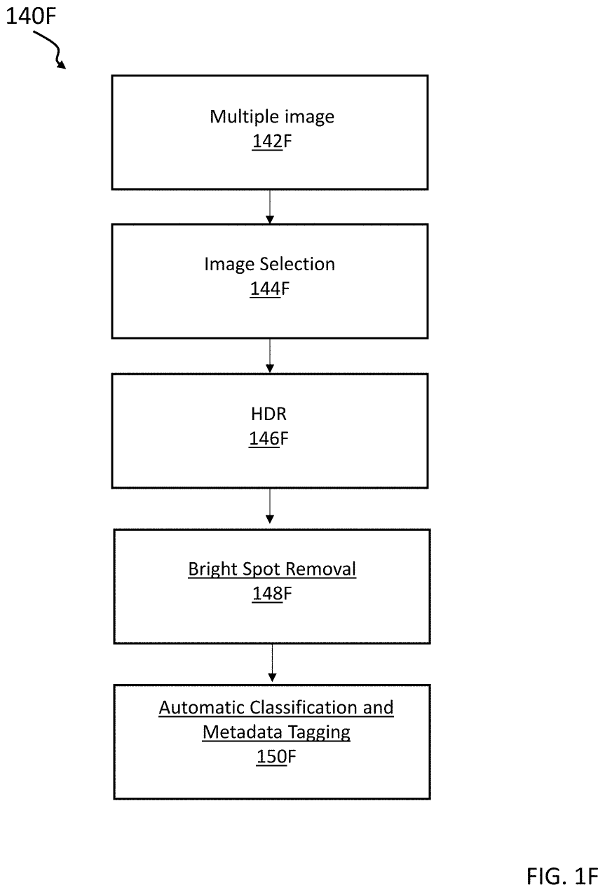

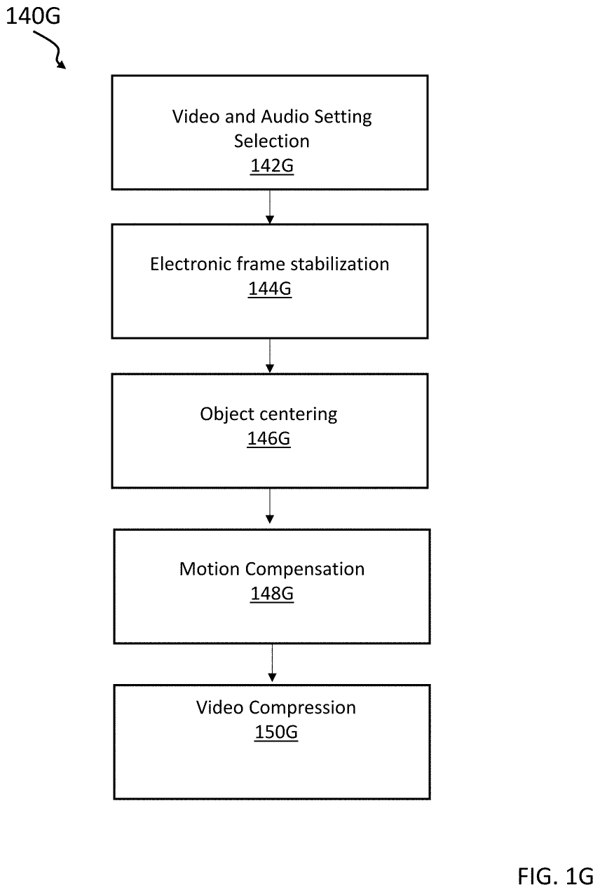

FIG. 1A illustrates one embodiment of a neural network supported image or video processing pipeline system and method 100A. This pipeline 100A can use neural networks at multiple points in the image processing pipeline. For example, neural network based image preprocessing that occurs before image capture (step 110A) can include use of neural networks to select one or more of ISO, focus, exposure, resolution, image capture moment (e.g. when eyes are open) or other image or video settings. In addition to using a neural network to simply select reasonable image or video settings, such analog and pre-image capture factors can be automatically adjusted or adjusted to favor factors that will improve efficacy of later neural network processing. For example, flash or other scene lighting can be increased in intensity, duration, or redirected. Filters can be removed from an optical path, apertures opened wider, or shutter speed decreased. Image sensor efficiency or amplification can be adjusted by ISO selection, all with a view toward (for example) improved neural network color adjustments or HDR processing.

After image capture, neural network based sensor processing (step 112A) can be used to provide custom demosaic, tone maps, dehazing, pixel failure compensation, or dust removal. Other neural network based processing can include Bayer color filter array correction, colorspace conversion, black and white level adjustment, or other sensor related processing.

Neural network based global post processing (step 114A) can include resolution or color adjustments, as well as stacked focus or HDR processing. Other global post processing features can include HDR in-filling, bokeh adjustments, super-resolution, vibrancy, saturation, or color enhancements, and tint or IR removal.

Neural network based local post processing (step 116A) can include red-eye removal, blemish removal, dark circle removal, blue sky enhancement, green foliage enhancement, or other processing of local portions, sections, objects, or areas of an image. Identification of the specific local area can involve use of other neural network assisted functionality, including for example, a face or eye detector.

Neural network based portfolio post processing (step 116A) can include image or video processing steps related to identification, categorization, or publishing. For example, neural networks can be used to identify a person and provide that information for metadata tagging. Other examples can include use of neural networks for categorization into categories such as pet pictures, landscapes, or portraits.

FIG. 1B illustrates a neural network supported image or video processing system 120B. In one embodiment, hardware level neural control module 122B (including settings and sensors) can be used to support processing, memory access, data transfer, and other low level computing activities. A system level neural control module 124B interacts with hardware module 122B and provides preliminary or required low level automatic picture presentation tools, including determining useful or needed resolution, lighting or color adjustments. Images or video can be processed using a system level neural control module 126B that can include user preference settings, historical user settings, or other neural network processing settings based on third party information or preferences. A system level neural control module 128B can also include third party information and preferences, as well as settings to determine whether local, remote, or distributed neural network processing is needed. In some embodiments, a distributed neural control module 130B can be used for cooperative data exchange. For example, as social network communities change styles of preferred portraits images (e.g. from hard focus styles to soft focus), portrait mode neural network processing can be adjusted as well. This information can be transmitted to any of the various disclosed modules using network latent vectors, provided training sets, or mode related setting recommendations.

FIG. 1C is another embodiment illustrating a neural network supported software system 120B. As shown, information about an environment, including light, scene, and capture medium is detected and potentially changed, for example, by control of external lighting systems or on camera flash systems. An imaging system that includes optical and electronics subsystems can interact with a neural processing system and a software application layer. In some embodiments, remote, local or cooperative neural processing systems can be used to provide information related to settings and neural network processing conditions.

In more detail, the imaging system can include an optical system that is controlled and interacts with an electronics system. The optical system contains optical hardware such as lense and an illumination emitter, as well electronic, software or hardware controllers of shutter, focus, filtering and aperture. The electronics system includes a sensor and other electronic, software or hardware controllers that provide filtering, set exposure time, provide analog to digital conversion (ADC), provide analog gain, and act as an illumination controller. Data from the imaging system can be sent to the application layer for further processing and distribution and control feedback can be provided to a neural processing system (NPS).

The neural processing system can include a front-end module, a back-end module, user preference settings, portfolio module, and data distribution module. Computation for modules can be remote, local, or through multiple cooperative neural processing systems either local or remote. The neural processing system can send and receive data to the application layer and the imaging system.

In the illustrated embodiment, the front-end includes settings and control for the imaging system, environment compensation, environment synthesis, embeddings, and filtering. The back-end provides linearization, filter correction, black level set, white balance, and demosaic. User preferences can include exposure settings, tone and color settings, environment synthesis, filtering, and creative transformations. The portfolio module can receive this data an provide categorization, person identification, or geotagging. The distribution module can coordinate sending a receiving data from multiple neural processing systems and send and receive embeddings to the application layer. The application layer provides a user interface to custom settings, as well as image or setting result preview. Images or other data can be stored and transmitted, and information relating to neural processing systems can be aggregated for future use or to simplify classification, activity or object detection, or decision making tasks.

FIG. 1D illustrates one example of neural network supported image processing 140D. Neural networks can be used to modify or control image capture settings in one or more processing steps that include exposure setting determination 142D, RGB or Bayer filter processing 142D, color saturation adjustment 142D, red-eye reduction 142D, or identifying picture categories such as owner selfies, or providing metadata tagging and internet mediated distribution assistance (142D).

FIG. 1E illustrates another example of neural network supported image processing 140E. Neural networks can be used to modify or control image capture settings in one or more processing steps that include denoising 142E, color saturation adjustment 144E, glare removal 146E, red-eye reduction 148E, and eye color filters 150E.

FIG. 1F illustrates another example of neural network supported image processing 140F. Neural networks can be used to modify or control image capture settings in one or more processing steps that can include but are not limited to capture of multiple images 142F, image selection from the multiple images 144F, high dynamic range (HDR) processing 146F, bright spot removal 148F, and automatic classification and metadata tagging 150F.

FIG. 1G illustrates another example of neural network supported image processing 140G. Neural networks can be used to modify or control image capture settings in one or more processing steps that include video and audio setting selection 142G, electronic frame stabilization 144G, object centering 146G, motion compensation 148G, and video compression 150G.

A wide range of still or video cameras can benefit from use neural network supported image or video processing pipeline system and method. Camera types can include but are not limited to conventional DSLRs with still or video capability, smartphone, tablet cameras, or laptop cameras, dedicated video cameras, webcams, or security cameras. In some embodiments, specialized cameras such as infrared cameras, thermal imagers, millimeter wave imaging systems, x-ray or other radiology imagers can be used. Embodiments can also include cameras with sensors capable of detecting infrared, ultraviolet, or other wavelengths to allow for hyperspectral image processing.

Cameras can be standalone, portable, or fixed systems. Typically, a camera includes processor, memory, image sensor, communication interfaces, camera optical and actuator system, and memory storage. The processor controls the overall operations of the camera, such as operating camera optical and sensor system, and available communication interfaces. The camera optical and sensor system controls the operations of the camera, such as exposure control for image captured at image sensor. Camera optical and sensor system may include a fixed lens system or an adjustable lens system (e.g., zoom and automatic focusing capabilities). Cameras can support memory storage systems such as removable memory cards, wired USB, or wireless data transfer systems.

In some embodiments, neural network processing can occur after transfer of image data to a remote computational resources, including a dedicated neural network processing system, laptop, PC, server, or cloud. In other embodiments, neural network processing can occur within the camera, using optimized software, neural processing chips, dedicated ASICs, custom integrated circuits, or programmable FPGA systems.

In some embodiments, results of neural network processing can be used as an input to other machine learning or neural network systems, including those developed for object recognition, pattern recognition, face identification, image stabilization, robot or vehicle odometry and positioning, or tracking or targeting applications. Advantageously, such neural network processed image normalization can, for example, reduce computer vision algorithm failure in high noise environments, enabling these algorithms to work in environments where they would typically fail due to noise related reduction in feature confidence. Typically, this can include but is not limited to low light environments, foggy, dusty, or hazy environments, or environments subject to light flashing or light glare. In effect, image sensor noise is removed by neural network processing so that later learning algorithms have a reduced performance degradation.

In certain embodiments, multiple image sensors can collectively work in combination with the described neural network processing to enable wider operational and detection envelopes, with, for example, sensors having different light sensitivity working together to provide high dynamic range images. In other embodiments, a chain of optical or algorithmic imaging systems with separate neural network processing nodes can be coupled together. In still other embodiments, training of neural network systems can be decoupled from the imaging system as a whole, operating as embedded components associated with particular imagers.

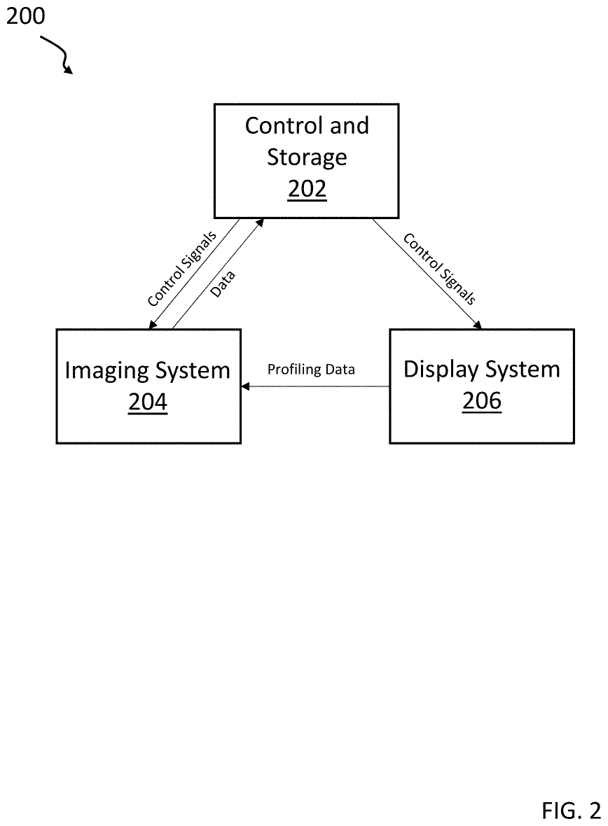

FIG. 2 generally describes hardware support for use and training of neural networks and image processing algorithms. In some embodiments, neural networks can be suitable for general analog and digital image processing. A control and storage module 202 able to send respective control signals to an imaging system 204 and a display system 206 is provided. The imaging system 204 can supply processed image data to the control and storage module 202, while also receiving profiling data from the display system 206. Training neural networks in a supervised or semi-supervised way requires high quality training data. To obtain such data, the system 200 provides automated imaging system profiling. The control and storage module 202 contains calibration and raw profiling data to be transmitted to the display system 206. Calibration data may contain, but is not limited to, targets for assessing resolution, focus, or dynamic range. Raw profiling data may contain, but is not limited to, natural and manmade scenes captured from a high quality imaging system (a reference system), and procedurally generated scenes (mathematically derived).

An example of a display system 206 is a high quality electronic display. The display can have its brightness adjusted or may be augmented with physical filtering elements such as neutral density filters. An alternative display system might comprise high quality reference prints or filtering elements, either to be used with front or back lit light sources. In any case, the purpose of the display system is to produce a variety of images, or sequence of images, to be transmitted to the imaging system.

The imaging system being profiled is integrated into the profiling system such that it can be programmatically controlled by the control and storage computer and can image the output of the display system. Camera parameters, such as aperture, exposure time, and analog gain, are varied and multiple exposures of a single displayed image are taken. The resulting exposures are transmitted to the control and storage computer and retained for training purposes.

The entire system is placed in a controlled lighting environment, such that the photon “noise floor” is known during profiling.

The entire system is setup such that the limiting resolution factor is the imaging system. This is achieved with mathematical models which take into account parameters, including but not limited to: imaging system sensor pixel pitch, display system pixel dimensions, imaging system focal length, imaging system working f-number, number of sensor pixels (horizontal and vertical), number of display system pixels (vertical and horizontal). In effect a particular sensor, sensor make or type, or class of sensors can be profiled to produce high-quality training data precisely tailored to an individual sensors or sensor models.

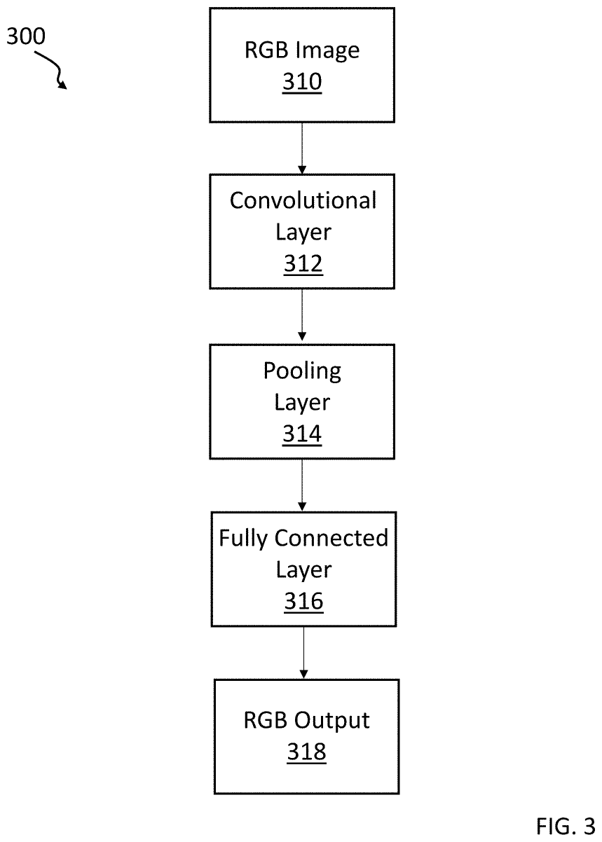

Various types of neural networks can be used with the systems disclosed with respect to FIG. 1B and FIG. 2, including fully convolutional, recurrent, generative adversarial, or deep convolutional networks. Convolutional neural networks are particularly useful for image processing applications such as described herein. As seen with respect to FIG. 3, a convolutional neural network 300 undertaking neural based sensor processing such as discussed with respect to FIG. 1A can receive a single underexposed RGB image 310 as input. RAW formats are preferred, but compressed JPG images can be used with some loss of quality. Images can be pre-processed with conventional pixel operations or can preferably be fed with minimal modifications into a trained convolutional neural network 300. Processing can proceed through one or more convolutional layers 312, pooling layer 314, a fully connected layer 316, and ends with RGB output 316 of the improved image. In operation, one or more convolutional layers apply a convolution operation to the RGB input, passing the result to the next layer(s). After convolution, local or global pooling layers can combine outputs into a single or small number of nodes in the next layer. Repeated convolutions, or convolution/pooling pairs are possible. After neural base sensor processing is complete, the RGB output can be passed to This RGB image can be passed to neural network based global post-processing for additional neural network based modifications.

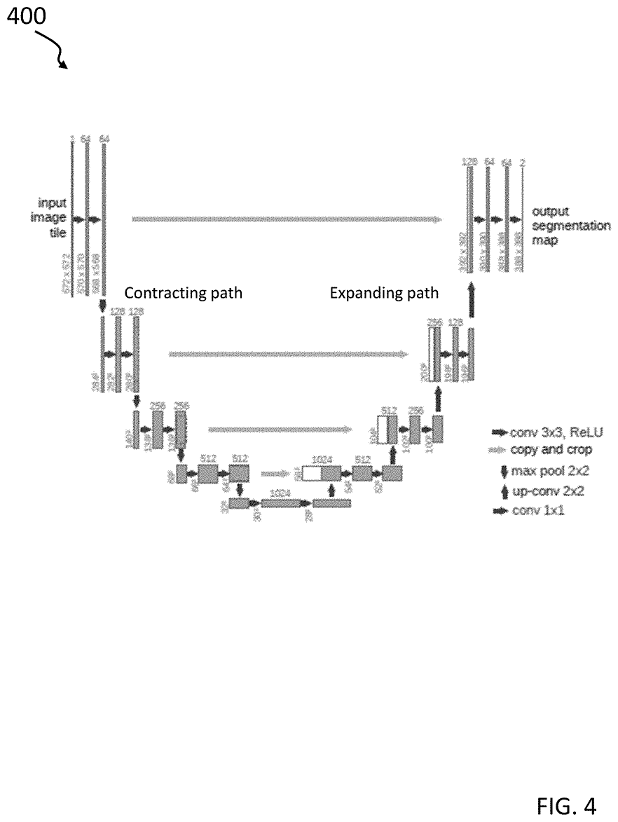

One neural network embodiment of particular utility is a fully convolutional neural network. A fully convolutional neural network is composed of convolutional layers without any fully-connected layers usually found at the end of the network. Advantageously, fully convolutional neural networks are image size independent, with any size images being acceptable as input for training or bright spot image modification. An example of a fully convolutional network 400 is illustrated with respect to FIG. 4. Data can be processed on a contracting path that includes repeated application of two 3×3 convolutions (unpadded convolutions), each followed by a rectified linear unit (ReLU) and a 2×2 max pooling operation with stride 2 for down sampling. At each down sampling step, the number of feature channels is doubled. Every step in the expansive path consists of an up sampling of the feature map followed by a 2×2 convolution (up-convolution) that halves the number of feature channels, provides a concatenation with the correspondingly cropped feature map from the contracting path, and includes two 3×3 convolutions, each followed by a ReLU. The feature map cropping compensates for loss of border pixels in every convolution. At the final layer a 1×1 convolution is used to map each 64-component feature vector to the desired number of classes. While the described network has 23 convolutional layers, more or less convolutional layers can be used in other embodiments. Training can include processing input images with corresponding segmentation maps using stochastic gradient descent techniques.

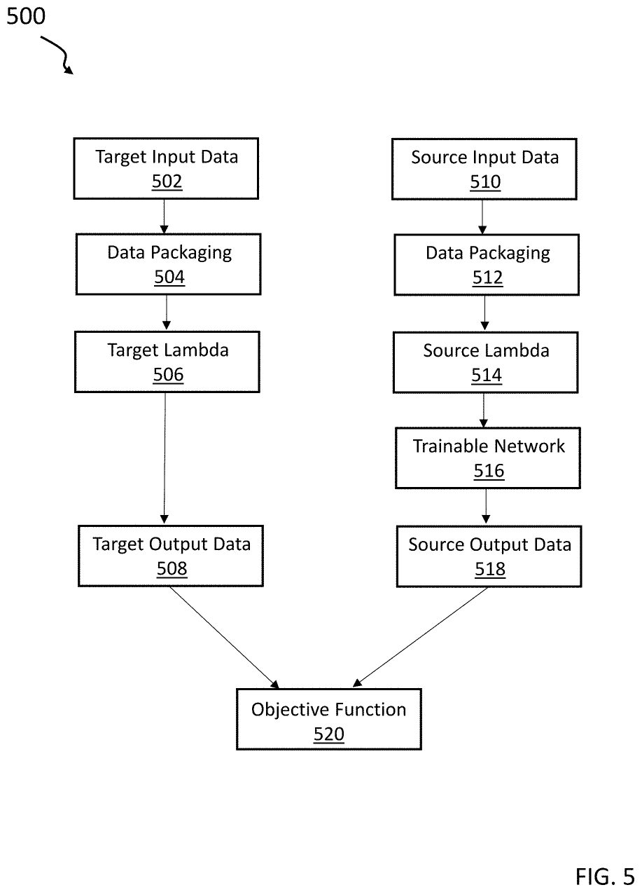

FIG. 5 illustrates one embodiment of a neural network training system 500 whose parameters can be manipulated such that they produce desirable outputs for a set of inputs. One such way of manipulating a network's parameters is by “supervised training”. In supervised training, the operator provides source/target pairs 510 and 502 to the network and, when combined with an objective function, can modify some or all the parameters in the network system 500 according to some scheme (e.g. backpropagation).

In the described embodiment of FIG. 5, high quality training data (source 510 and target 502 pairs) from various sources such as a profiling system, mathematical models and publicly available datasets, are prepared for input to the network system 500. The method includes data packaging target 504 and source 512, and preprocessing lambda target 506 and source 514.

Data packaging takes one or many training data sample(s), normalizes it according to a determined scheme, and arranges the data for input to the network in a tensor. Training data sample may comprise sequence or temporal data.

Preprocessing lambda allows the operator to modify the source input or target data prior to input to the neural network or objective function. This could be to augment the data, to reject tensors according to some scheme, to add synthetic noise to the tensor, to perform warps and deformation to the data for alignment purposes or convert from image data to data labels.

The network 516 being trained has at least one input and output 518, though in practice it is found that multiple outputs, each with its own objective function, can have synergetic effects. For example, performance can be improved through a “classifier head” output whose objective is to classify objects in the tensor. Target output data 508, source output data 518, and objective function 520 together define a network's loss to be minimized, the value of which can be improved by additional training or data set processing.

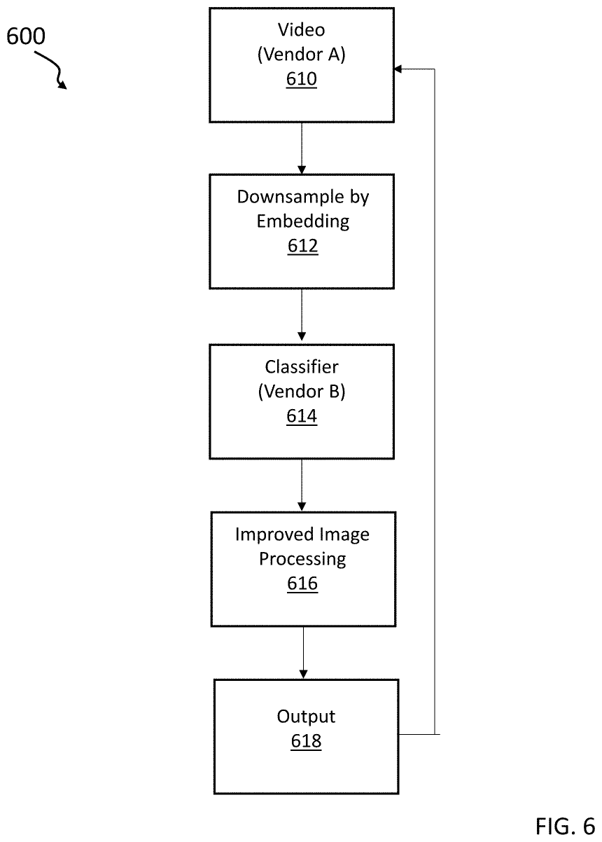

FIG. 6 is a flow chart illustrating one embodiment of an alternative, complementary, or supplementary approach to neural network processing. Known as neural embedding, dimensionality of a processing problem can be reduced and image processing speed by greatly improved. Neural embedding provides a mapping of a high dimensional image to a position on a low-dimensional manifold represented by a vector (“latent vector”). Components of the latent vector are learned continuous representations that may be constrained to represent specific discrete variables. In some embodiments a neural embedding is a mapping of a discrete variable to a vector of continuous numbers, providing low-dimensional, learned continuous vector representations of discrete variables. Advantageously this allows, for example, their input to a machine learning model for a supervised task or finding nearest neighbors in the embedding space.

In some embodiments, neural network embeddings are useful because they can reduce the dimensionality of categorical variables and represent categories in the transformed space. Neural embeddings are particularly useful for categorization, tracking, and matching, as well as allowing a simplified transfer of domain specific knowledge to new related domains without needing a complete retraining of a neural network. In some embodiments, neural embeddings can be provided for later use, for example by preserving a latent vector in image or video metadata to allow for optional later processing or improved response to image related queries. For example, a first portion of an image processing system can be arranged to reduce data dimensionality and effectively downsample an image, images, or other data using a neural processing system to provide neural embedding information. A second portion of the image processing system can also be arranged for at least one of categorization, tracking, and matching using neural embedding information derived from the neural processing system. Similarly, neural network training system can include a first portion of a neural network algorithm arranged to reduce data dimensionality and effectively downsample an image or other data using a neural processing system to provide neural embedding information. A second portion of a neural network algorithm is arranged for at least one of categorization, tracking, and matching using neural embedding information derived from a neural processing system and a training procedure is used to optimize the first and second portions of the neural network algorithm.

In some embodiments, a training and inference system can include a classifier or other deep learning algorithm that can be combined with the neural embedding algorithm to create a new deep learning algorithm. The neural embedding algorithm can be configured such that its weights are trainable or non-trainable, but in either case will be fully differentiable such that the new algorithm is end-to-end trainable, permitting the new deep learning algorithm to be optimized directly from the objective function to the raw data input.

During inference, the above described algorithm (C) can be partitioned such that the embedding algorithm (A) executes on an edge or endpoint device, while the algorithm (B) can execute on a centralized computing resource (cloud, server, gateway device).

More specifically, as seen in FIG. 6, a one embodiment of a neural embedding process 600 begins with video provided by a Vendor A (step 610). The video is downsampled by embedding (step 612) to provide a low dimensional input for Vendor B's classifier (step 614). Vendor B's classifier benefits from reduced computation cost to provide improved image processing (step 616) with reduced loss of accuracy for output 618. In some embodiments, images, parameters, or other data from the output 618 of the improved image processing step 616 can be provided to Vendor A by Vendor B to improve the embedding step 612.

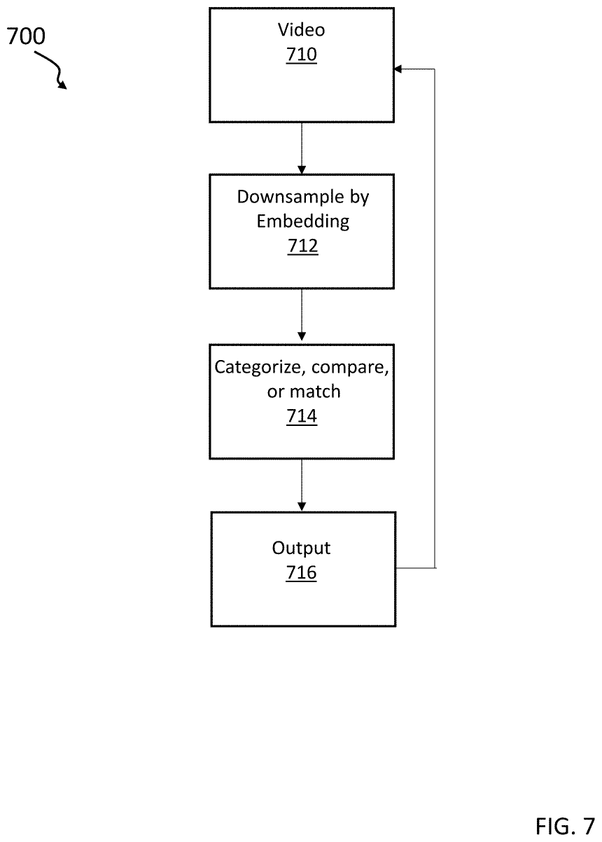

FIG. 7 illustrates another neural embedding process 700 useful for categorization, comparing, or matching. As seen in FIG. 7, one embodiment of the neural embedding process 700 begins with video (step 710). The video is downsampled by embedding (step 712) to provide a low dimensional input available for addition categorization, comparison, or matching (step 714). In some embodiments output 716 can be directly used, while in other embodiments, parameters or other data output from step 716 can be used to improve the embedding step.

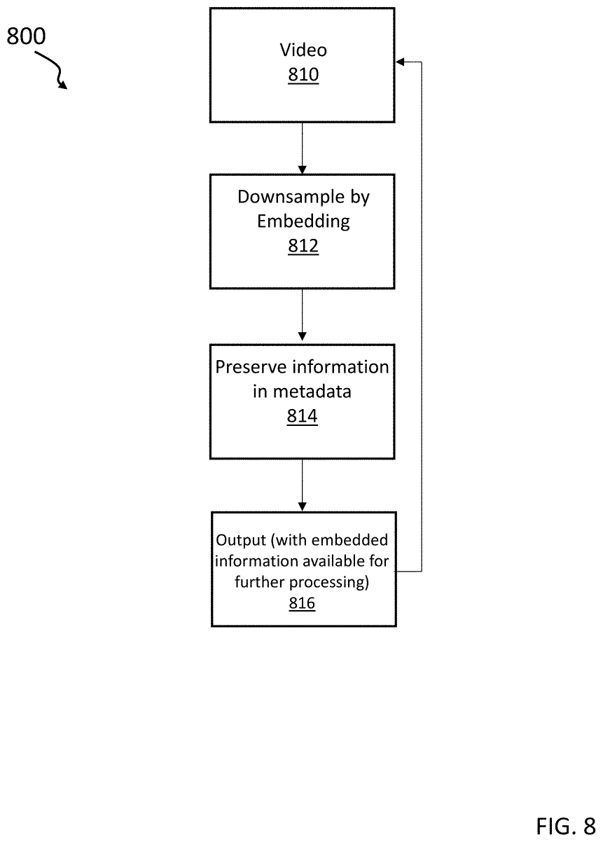

FIG. 8 illustrates a process for preserving neural embedding information in metadata. As seen in FIG. 8, one embodiment of the neural embedding process 800 suitable for metadata creation begins with video (step 810). The video is downsampled by embedding (step 812) to provide a low dimensional input available for insertion into searchable metadata associated with the video (step 814). In some embodiments output 816 can be directly used, while in other embodiments, parameters or other data output from step 816 can be used to improve the embedding step.

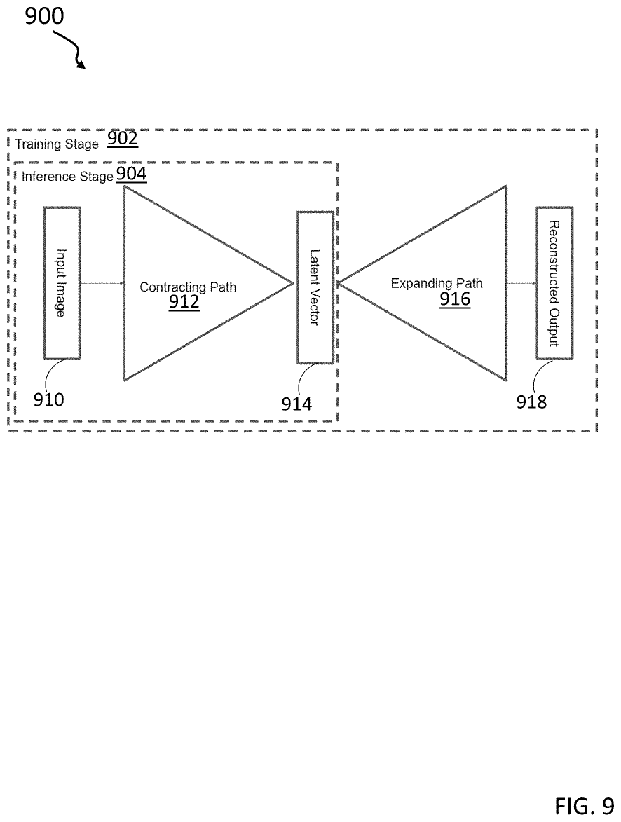

FIG. 9 illustrates a general process 900 for defining and utilizing a latent vector derived from still or video images in a neural network system. As seen in FIG. 9, processing can generally occur first in a training stage mode 902, followed by trained processing in an inference stage mode 904. An input image 910 is passed along a contracting neural processing path 912 for encoding. In the contracting path 912 (i.e. encoder), neural network weights are learned to provide a mapping from high dimensional input images to a latent vector 914 with smaller dimensionality. The expanding path 916 (decoder) can be jointly learned to recover the original input image from the latent vector. In effect, the architecture can create an “information bottleneck” that can encode only the most useful information for a video or image processing task. After training many online purposes only require the encoder portion of the network.

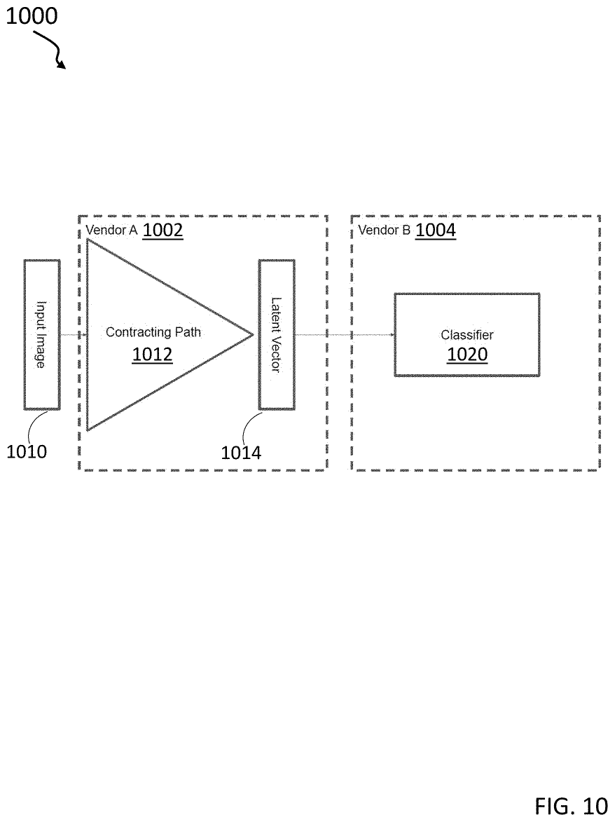

FIG. 10 illustrates a general procedure 1000 for using latent vectors to pass information between modules in a neural network system. In some embodiments, the modules can be provided by different vendors (e.g. Vendor A (1002) and Vendor B (1004)), while in other embodiments processing can be done by a single processing service provider. FIG. 10 illustrates a neural processing path 1012 for encoding. In the contracting path 1012 (i.e. encoder), neural network weights are learned to provide a mapping from high dimensional input images to a latent vector 1014 with smaller dimensionality. This latent vector 1014 can be used for subsequent input to a classifier 1020. In some embodiments, classifier 1020 can be trained with {latent, label} pairs, as opposed to {image, label} pairs. The classifier benefits from reduced input complexity, and the high quality features provided by the neural embedding “backbone” network.

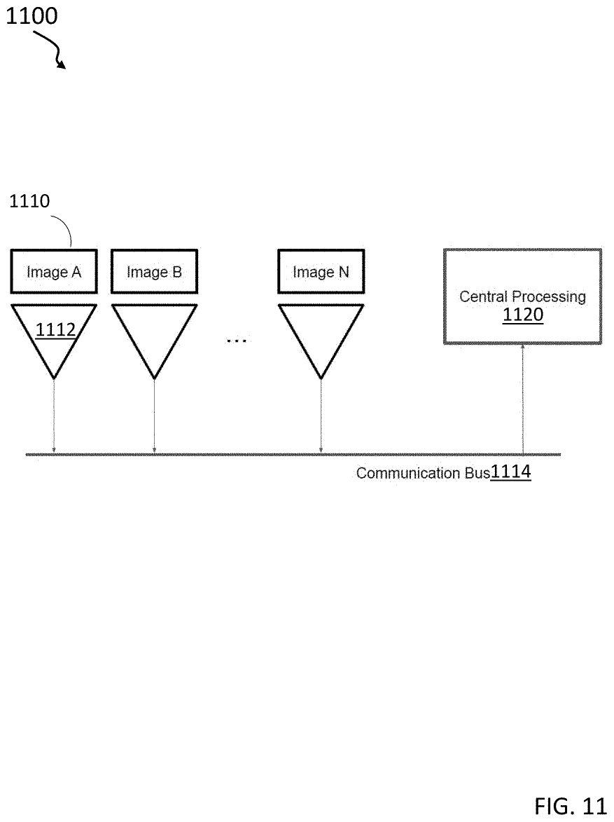

FIG. 11 illustrates bus mediated communication of neural network derived information, including a latent vector. For example, multi-sensor processing system 1100 can operate to send information derived from one or more images 1110 and processed using neural processing path 1112 for encoding. This latent vector, along with optional other image data or metadata can sent over a communication bus 1114 or other suitable interconnect to a centralized processing module 1120. In effect, this allows individual imaging systems to make use of neural embeddings to reduce bandwidth requirements of the communication bus, and subsequent processing requirements in the central processing module 1120.

Bus mediation communication of neural networks such as discussed with respect to FIG. 11 can greatly reduce data transfer requirements and costs. For example, a city, venue, or sports arena IP-camera system can be configured so that each camera outputs latent vectors for a video feed. These latent vectors can supplement or entirely replace images sent to a central processing unit (eg. gateway, local server, VMS, etc). The received latent vectors can be used to performs video analytics or combined with original video data to be presented to human operators. This allows performance of realtime analysis on hundreds or thousands of cameras, without needing access to large data pipeline and a large and expensive server.

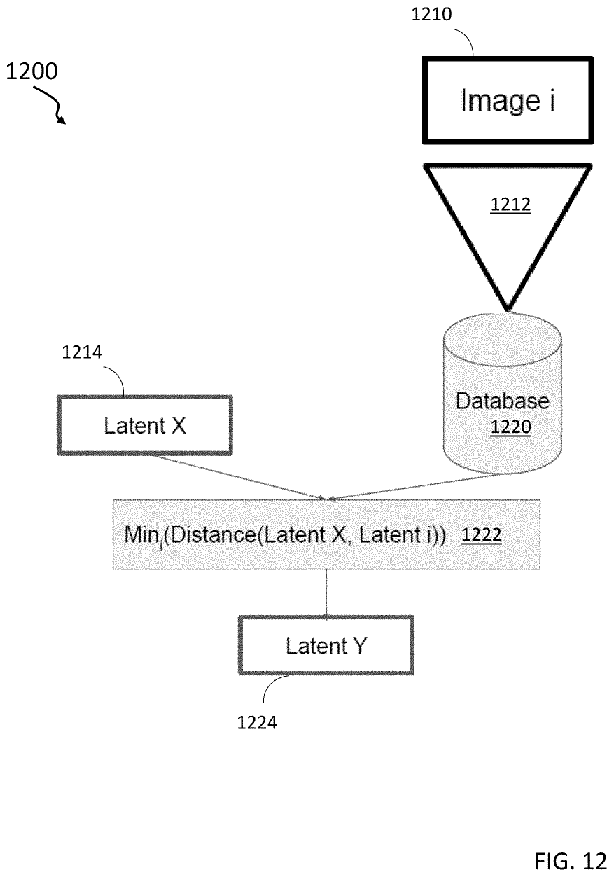

FIG. 12 illustrates a process 1200 for image database searching using neural embedding and latent vector information for identification and association purposes. In some embodiments, images 1210 can be processed along a contracting neural processing path 1212 for encoding into data that includes latent vectors. The latent vectors resulting from a neural embedding network can be stored in a database 1220. A database query that includes latent vector information (1214) can be made, with the database operating to identify latent vectors closest in appearance to a given latent vector X according to some scheme. For example, in one embodiment a euclidean distance between latent vectors (e.g. 1222) can be used to find a match, though other schemes are possible. The resulting match may be associated with other information, including the original source image or metadata. In some embodiments, further encoding is possible, providing another latent vector 1224 that can be stored, transmitted, or added to image metadata.

As another example, a city, venue, or sports arena IP-camera system can be configured so that each camera outputs latent vectors that are stored or otherwise made available for video analytics. These latent vectors can be searched to identify objects, persons, scenes, or other image information without needing to provide real time searching of large amounts of image data. This allows performance of realtime video or image analysis on hundreds or thousands of cameras to find, for example, a red car associated with a certain person or scene, without needing access to large data pipeline and a large and expensive server.

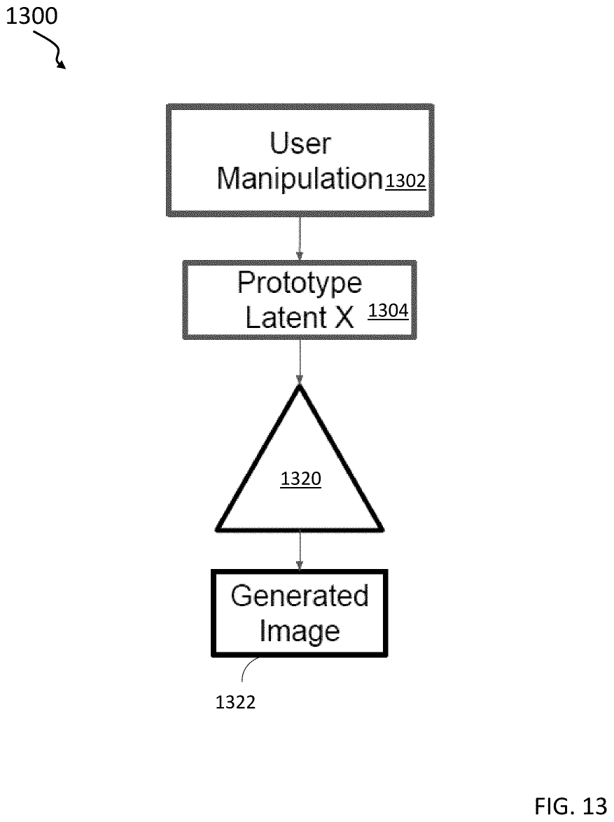

FIG. 13 illustrates a process 1300 for user manipulation of latent vector. For example, images can be processed along a contracting neural processing path for encoding into data that includes latent vectors. A user may manipulate (1302) the input latent vector to obtain novel images by directly changing the vector elements, or by combining several latent vectors (latent space arithmetic, 1304). The latent vector can be expanded using expanding path processing (1320) to provide a generated image (1322). In some embodiments, this procedure can be repeated or iterated to provide a desired image.

As will be understood, the camera system and methods described herein can operate locally or in via connections to either a wired or wireless connect subsystem for interaction with devices such as servers, desktop computers, laptops, tablets, or smart phones. Data and control signals can be received, generated, or transported between varieties of external data sources, including wireless networks, personal area networks, cellular networks, the Internet, or cloud mediated data sources. In addition, sources of local data (e.g. a hard drive, solid state drive, flash memory, or any other suitable memory, including dynamic memory, such as SRAM or DRAM) that can allow for local data storage of user-specified preferences or protocols. In one particular embodiment, multiple communication systems can be provided. For example, a direct Wi-Fi connection (802.11b/g/n) can be used as well as a separate 4G cellular connection.

Connection to remote server embodiments may also be implemented in cloud computing environments. Cloud computing may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

The flow diagrams and block diagrams in the described Figures are intended to illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. An image processing pipeline including a still or video camera, comprising:
a first portion of an image processing system arranged to use information derived at least in part from neural embedding information; and
a second portion of the image processing system used to modify at least one of an image capture setting, sensor processing, global post processing, local post processing, and portfolio post processing, based at least in part on the neural embedding information.

2. The image processing pipeline of claim 1, wherein the neural embedding information includes a latent vector.

3. The image processing pipeline of claim 1, wherein the neural embedding information includes at least one latent vector that is sent between modules in the image processing system.

4. The image processing pipeline of claim 1, wherein the neural embedding includes at least one latent vector that is sent between one or more neural networks in the image processing system.

5. An image processing pipeline including a still or video camera, comprising:
a first portion of an image processing system arranged to reduce data dimensionality and effectively downsample an image, images, or other data using a neural processing system to create neural embedding information; and
a second portion of the image processing system arranged to modify at least one of an image capture setting, sensor processing, global post processing, local post processing, and portfolio post processing, based at least in part on the neural embedding information.

6. The image processing pipeline of claim 5, wherein the neural embedding information includes a latent vector.

7. The image processing pipeline of claim 5, wherein the neural embedding information includes at least one latent vector that is sent between modules in the image processing system.

8. The image processing pipeline of claim 5, wherein the neural embedding includes at least one latent vector that is sent between one or more neural networks in the image processing system.

9. An image processing pipeline including a still or video camera, comprising:
a first portion of an image processing system arranged for at least one of categorization, tracking, and matching using neural embedding information derived from a neural processing system; and;
a second portion of the image processing system arranged to modify at least one of an image capture setting, sensor processing, global post processing, local post processing, and portfolio post processing, based at least in part on the neural embedding information.

10. The image processing pipeline of claim 9, wherein the neural embedding information includes a latent vector.

11. The image processing pipeline of claim 9, wherein the neural embedding information includes at least one latent vector that is sent between modules in the image processing system.

12. The image processing pipeline of claim 9, wherein the neural embedding includes at least one latent vector that is sent between one or more neural networks in the image processing system.

13. An image processing pipeline including a still or video camera, comprising:
a first portion of an image processing system arranged to reduce data dimensionality and effectively downsample an image, images, or other data using a neural processing system to provide neural embedding information; and
a second portion of the image processing system arranged to preserve the neural embedding information within image or video metadata.

14. The image processing pipeline of claim 13, wherein the neural embedding information includes a latent vector.

15. The image processing pipeline of claim 13, wherein the neural embedding information includes at least one latent vector that is sent between modules in the image processing system.

16. The image processing pipeline of claim 13, wherein the neural embedding includes at least one latent vector that is sent between one or more neural networks in the image processing system.

17. An image processing pipeline including a still or video camera, comprising:
a first portion of an image processing system arranged to reduce data dimensionality and effectively downsample an image, images, or other data using a neural processing system to provide neural embedding information; and
a second portion of the image processing system arranged for at least one of categorization, tracking, and matching using neural embedding information derived from the neural processing system.

18. The image processing pipeline of claim 17, wherein the neural embedding information includes a latent vector.

19. The image processing pipeline of claim 17, wherein the neural embedding information includes at least one latent vector that is sent between modules in the image processing system.

20. The image processing pipeline of claim 17, wherein the neural embedding includes at least one latent vector that is sent between one or more neural networks in the image processing system.

21. A neural network training system, comprising:
a first portion having a neural network algorithm arranged to reduce data dimensionality and effectively downsample an image, images, or other data using a neural processing system to provide neural embedding information;
a second portion having a neural network algorithm arranged for at least one of categorization, tracking, and matching using neural embedding information derived from a neural processing system; and
a training procedure that optimizes operation of the first and second portions of the neural network algorithm.
